(19) United States
(12) Patent Application Publication
(10) Pub. No.: US 2011/0089108 A1
(43) Pub. Date: Apr. 21, 2011

(54) Aeration and filtration system and process for treating wastewater

(75) Inventor: Max Zigerlig, San Paulo (BR)

(73) Assignee: MAZZEI INJECTOR COMPANY, LLC, Bakersfield, CA (US)

(21) Appl. No.: 12/999,950

(22) PCT Filed: Jun. 24, 2009
(86) PCT No.: PCT/IB2009/006043

§ 371 Date: Dec. 17, 2010

(30) Foreign Application Priority Data
Jun. 25, 2008 (CH) 00965/08

(51) Int. Cl. C02F 3/20; C02F 3/12

(52) U.S. Cl. 210/626; 210/195.2

(57) ABSTRACT

An aeration and filtration system and process for treating wastewater is described, the system having an ejector able to mix gas and liquid, an oxidation tank able to contain a solution of wastewater and biological sludge, a filtration means, a pipe able to convey the wastewater and biological sludge solution from the oxidation tank to the filtration means. The pipe is connected to the ejector so as to introduce a turbulence inside the pipe; moreover the filtration means is equipped with a membrane which has micropores.

### BACKGROUND

The present invention relates to the technical sector of wastewater purification.

In particular, the present invention concerns an aeration and filtration system and a process for treating wastewater.

In the technical sector of wastewater purification, bioreactors equipped with a filtration membrane device are becoming widespread as the latest technology. Usually, in this type of system, a membrane-filtration device is combined with a conventional active-sludge biological purifier and replaces the final sedimentation tank.

In connection with the present invention, a bioreactor is defined as being a device able to provide a suitable environment for the growth of biological organisms which, inside the purifier, allow elimination of the polluting load, comprising organic carbon (C), nitrogen (N) and potassium (K), these being introduced into the corresponding compounds of the life cycle of the bacteria which form the so-called biological sludge. The bioreactor comprises an oxidation tank made of stainless steel, plastic reinforced by fiber glass or cement, which may reach a size ranging from a few to many cubic metres and may contain a mixture of wastewater and biological sludge.

These systems envisage moreover a membrane which has a microporous structure. The membrane therefore performs the function of separating the purified water from the biological sludge, which must be retained inside the bioreactor, using the physical principle of filtration. In this way loss of the sludge from the treated water is prevented, the sludge concentration and therefore purification capacity are increased, the manufacture of more compact plants is possible, and management thereof is facilitated since it is not required to guarantee the sedimentation capacity of the sludge.

The membrane bioreactor therefore combines biological treatment of the wastewater with a solid/liquid separation process by means of filtration membranes.

The Applicant has noted that in such systems the filtration membrane is usually immersed inside the oxidation tank of the bioreactor or is external, situated upstream of the device for adding oxygen to the sludge, and the biological sludge solution is circulated inside them by means of a hydraulic pump.

AU 2000116433 describes a system of the abovementioned type, comprising a tank, in the form of a reactor, for maintaining a mixture of wastewater and biomass under aerobic conditions. A flow of mixture is removed from the tank and pumped through a microfilter so as to separate at least one substantial portion of biomass and provide a flow of treated discharge product and a flow of biomass circulating in the reactor.

The Applicant has noted that in this type of system the membrane may be easily contaminated owing to the high concentration of biological sludge in the mixture.

The Applicant has also noted that in this type of system, owing to the high concentration of biological sludge present in the bioreactor, one of the difficulties encountered during operation is that of transferring the oxygen to the water/sludge solution, with a consequent high energy demand.

The object of the present invention is to overcome the abovementioned drawbacks and propose an aeration and filtration system and process for treating wastewater, in which aeration and filtration are performed in a single and sole operation.

### SUMMARY OF THE INVENTION

According to a first aspect the present invention concerns an aeration and filtration system for treating wastewater, comprising:

at least one oxidation tank able to contain a mixture of wastewater and biological sludge;

at least one ejector able to mix gas comprising oxygen with at least one portion of said wastewater and biological sludge mixture;

at least one filtration device;

at least one pipe able to convey the wastewater and biological sludge mixture from the oxidation tank to the said at least one filtration device; characterized in that:

the said at least one ejector is arranged along side pipe and the said at least one filtration device is situated downstream of the said at least one ejector (4) and comprises at least one filtration membrane comprising micropores.

The present invention, with regard to the abovementioned aspect, may have at least one of the preferred characteristic features which are described hereinbelow.

Preferably, the ejector may be a Venturi ejector.

Advantageously, the ejector may be positioned above the oxidation tank and may be able to mix a predefined quantity of air with a wastewater and biological sludge mixture.

Advantageously, the ejector comprises a body with an inlet opening, an outlet opening and a passage which passes through said body, said passage having an inlet section communicating with the said inlet opening, an outlet section communicating with said outlet opening, a constricting section, a substantially cylindrical throat section and an expanding section between said inlet section and said outlet section, an injector intake port formed in the said throat section, said constricting section and said throat section being suitably designed to form a reduced-pressure region along the said throat section.

Preferably, the filtration device may be formed by at least one duct and an outer containing sleeve functionally connected to the ejector.

Advantageously, the duct comprises a filtration membrane.

Preferably, the membrane is a microfiltration membrane with micropores having a size ranging between 0.01 and 0.2 micron.

Advantageously, the membrane is a tubular microfiltration membrane with a diameter D ranging between 3 mm and 15 mm.

Preferably, the membrane is a tubular microfiltration membrane with a length L ranging between 1000 mm and 5000 mm.

Advantageously, the device is equipped with at least one main pumping device (P1) in the case where it is also necessary provide a reduction in the nitrogen pollution load.

Preferably, the main pumping device (P1) has dimensions such to produce a flow rate of the liquid circulating in the system, equal to less than 3.5 m/s.

Advantageously, the system is equipped with at least one secondary pumping device (P2) for conveying the liquid fraction which filters through the filtration device to a temporary storage tank (S1).

Preferably, the system also comprises a denitrification tank situated upstream of the main pumping device (P1).

Aeration and filtration system and process for treating wastewater with a system comprising:

at least one oxidation tank able to contain a mixture of wastewater and biological sludge;

at least one ejector able to mix gas comprising oxygen and at least one portion of said wastewater and biological sludge mixture;

at least one filtration device;

at least one pipe able to convey the wastewater and biological sludge solution from the oxidation tank to the said at least one filtration device; the process comprising the steps of:

drawing off a quantity of wastewater and biological sludge mixture from the said sedimentation tank;

adding oxygen to the said wastewater and biological sludge mixture;

filtering the oxygenated flow of the wastewater and biological sludge mixture so as to obtain discharge liquid;

discharging the said discharge liquid;

introducing the remaining portion of oxygenated wastewater and biological sludge mixture into the oxidation tank;

Preferably, the step of introducing the remaining portion of the wastewater and biological sludge mixture comprises a step of adding oxygen inside the said sedimentation tank.

Advantageously, the step of adding oxygen inside the said oxidation tank is performed by means of the movement induced by at least one mixer nozzle.

Preferably the step of filtering the flow of the oxygenated wastewater and biological sludge mixture so as to obtain discharge liquid comprises a step of adding oxygen by means of the turbulence created by a tubular filtration membrane.

Advantageously, the flow of the wastewater and biological sludge mixture may undergo a denitrification step in order to eliminate or in any case reduce the nitrogen in the form of elementary nitrogen.

The process and the system according to the present invention is particularly effective in the case of purification plants which treat a waste product which contains a large amount of organic substance and which must therefore use high concentrations of biological sludge in the oxidation tank.

In these cases, the oxygen requirement is high and consequently oxygen transfer becomes the decisive factor in terms of energy consumption.

In the system and the process according to the present invention the oxygen is transferred in an efficient manner in three stages:

the first transfer occurs in the ejector, owing to the extremely high turbulence;

the second transfer occurs in the membrane ducts, again owing to the high turbulence and to the pressure improving the oxygen dissolution;

the third transfer occurs inside the oxidation tank owing to the movement induced by the mixer nozzles;

The advantage compared to conventional devices which use porous diffusers situated inside the oxidation tank and supplied by a suitable blower is obvious. In these devices transfer occurs in a single transfer stage inside the oxidation tank with a high sludge concentration which prevents gas/liquid contact.

Another advantage of the device consists in the possibility of using a high liquid head in the oxidation tank, increasing further the efficiency in terms of oxygen transfer. The energy consumption of the device is in fact practically independent of the liquid head since this influences the recirculation pump during both intake and delivery. In conventional systems, instead, the energy consumption of the blower increases in a more than proportional manner in relation to the liquid head.

The energy downstream of the ejector is reutilized entirely for operation of the microfiltration membrane. In a conventional tangential filtration system, the membrane is supplied by a separate pump, the energy consumption of which must be added to that of the other apparatus installed in the plant.

In the invention, instead, filtration is performed practically using only the residual energy present in the flow circulating downstream of the ejector.

Further characteristic features and advantages of the invention will appear more clearly from the following detailed description of a number of preferred, but not exclusive embodiments, of an aeration and filtration system and process for treating wastewater, according to the present invention.

### BRIEF DESCRIPTION OF THE DRAWINGS

This description is provided hereinbelow with reference to the accompanying drawings, provided solely by way of a non-limiting example, in which:

FIG. 1 is a schematic side view of the an aeration and filtration system for treating wastewater, according to the present invention;

FIG. 2 is a partially cross-sectioned, schematic, perspective view of a filtration device according to the present invention;

FIG. 3 is a schematic cross-sectional view, on a larger scale, of an ejector according to the present invention; and

FIG. 4 is a schematic view of a second embodiment of an aeration and filtration system for treating wastewater, according to the present invention.

### DETAILED DESCRIPTION OF THE EMBODIMENTS

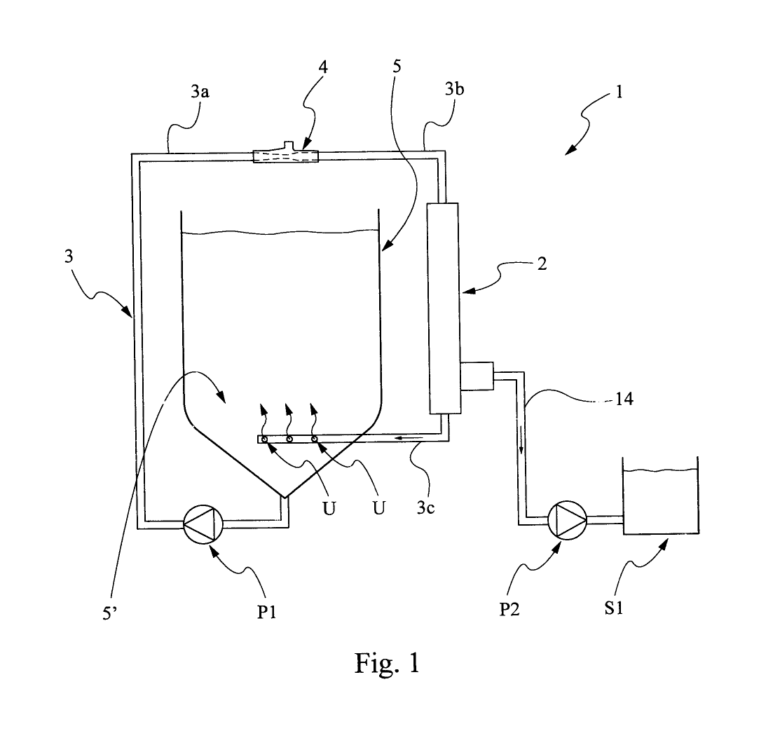

With reference to FIGS. 1 to 4, an aeration and filtration system for treating wastewater is indicated by the reference number 1. In a preferred embodiment shown in FIG. 1, the aeration and filtration system 1 for treating wastewater comprises:

a Venturi ejector 4;

an oxidation tank 5 able to contain a mixture of wastewater mixed with biological sludge 5′;

a filtration device 2;

at least one pipe 3 for conveying the wastewater and biological sludge solution 5′ from the tank 5 to the filtration device 2.

In detail the pipe 3 connects the sedimentation tank to the ejector 4 and the ejector 4 to the filtration device 2.

In other words, the ejector is arranged along said pipe 3 and the filtration device 2 is situated downstream of the ejector 4.

A further portion 3c of the pipe 3 which connects the filtration device 2 to the oxidation tank 5 is provided downstream of the filtration device 2.

In this way, downstream of the filtration device 2, the biological sludge portion, which is treated by the filtration device 2 and must be retained by the system 1, returns into the oxidation tank 5. In this way the loss of sludge from the treated water is prevented and the sludge concentration and therefore the purification capacity of the system are increased.

The treated and aerated sludge portion, supplied from the filtration device 2, is introduced into the oxidation tank 5 by means of one or more mixer nozzles U.

For this purpose, at least one mixer nozzle U is provided inside the oxidation tank 5.

Preferably three mixer nozzles U are provided, being installed in the bottom of the oxidation tank and being spaced circumferentially at about 120° from each other. In this way stratification inside the oxidation tank 5 is prevented.

The number of mixer nozzles U depends on the size of the oxidation tank.

By way of example, two or three mixer nozzles U are generally sufficient for oxidation tanks with a capacity ranging from 4 m³ to 20 m³.

The mixer nozzles U, as described more fully below, use the residual energy downstream of the filtration device 2 in order to mix the biological sludge inside the oxidation tank 5, helping use in an optimum manner the energy output by the electric motor of the main pumping device P1.

The ejector 4 as mentioned above is a Venturi ejector.

The ejector 4 mixes a stream of air and hence oxygen with the solution of water and biological sludge 5′ circulating inside the pipe 3.

An ejector of this type is for example described in the patent EP 1035912 cited here for reference purposes.

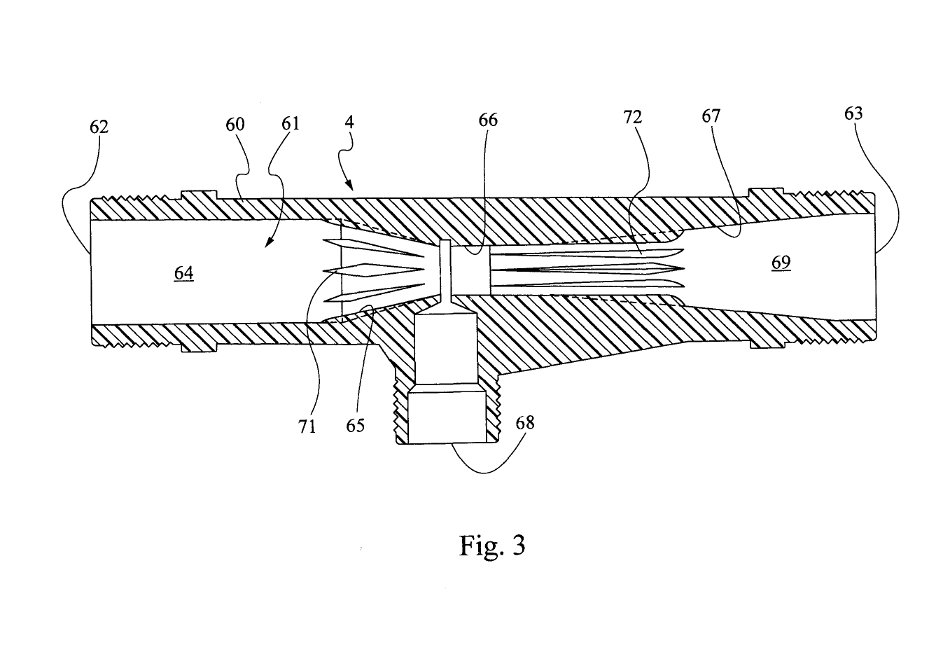

Such an ejector, as shown more clearly in FIG. 3, has a body 60 with an inlet opening 62, an outlet opening 63 and a passage which passes through it from one side to the other.

The passage is defined by a wall with a circular cross-section which extends along a central axis from the inlet opening 62 to the outlet opening 63.

Preferably, the passage 61 has an inlet portion 64, communicating with the inlet opening 62, an outlet portion 69 communicating with the outlet opening 63, a constricting portion 65, a substantially cylindrical throat portion 66, and an expanding portion 67 between said inlet portion 64 and the outlet portion 69.

The inlet portion 64 and the throat portion 66 have a substantially constant cross-section, while the constricting portion 65 and the expanding portion 67 have variable cross-sections.

In detail, the constricting portion 65 has a cross-section decreasing from the inlet portion 64 in the direction of the throat portion 66 and the expanding portion 67 has a cross-section increasing from the throat portion 66 in the direction of the outlet opening 63.

The ejector 4 also has an intake opening 68 which is formed in the throat portion 66. The constricting portion 65 and the throat portion 66 have relative dimensions such as to form a reduced-pressure region along the throat portion 66.

The ejector 4 is constructed so that, in the constricting portion 65, the speed of the wastewater mixed with sludge 5′ increases and the pressure falls to a value close to P=0 KPa absolute. In the expanding portion, once air has been sucked into the throat portion 66, the speed decreases and is recovered with an efficiency of up to 50% of the inlet pressure.

This pressure will be used downstream of the filtration device 2, as explained in greater detail below.

The ejector 4 may comprise, as for example shown in FIG. 3, a plurality of fluid twisting vanes 71, situated in the constricting portion 65, and a plurality of fluid straightening vanes 72, situated in the expanding portion 67.

The twisting vanes 71, as well as the straightening vanes 72, are situated circumferentially and spaced from each other.

The filtration device 2 is situated directly downstream of the ejector device 4 and directly connected to the latter via the portion 3b of the pipe 3.

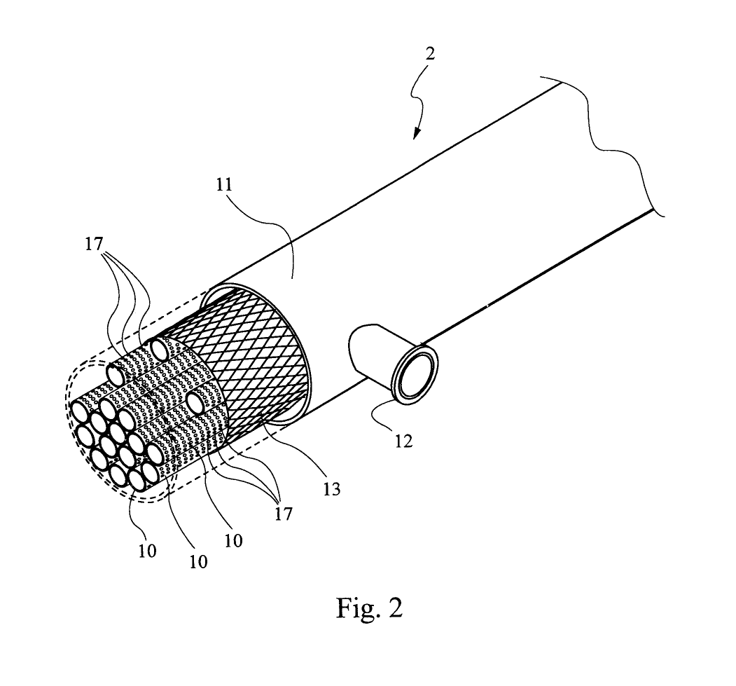

The filtration device 2, as can be seen clearly in FIG. 2, comprises at least one tubular membrane duct 10, an outer sleeve 11 for containing the tubular membrane duct 10, and an outlet 12 for discharging the filtered liquid.

The filtration device 2 is connected upstream to the said ejector 4 and downstream via the portion 3c of the pipe 3 to the oxidation tank 5.

The filtration device 2 is arranged vertically, such an arrangement preventing stratification of the gas.

In the preferred embodiment shown in FIG. 2, the filtration device 2 comprises a plurality of membrane ducts 10, each membrane duct 10 comprising at least one microfiltration membrane with micropores 17 having a size ranging from 0.01 to 0.2 micron.

Each tubular membrane duct 10 has a substantially constant circular cross-section along its extension with a diameter D ranging between 3.5 and 15 mm, preferably between 4 mm and 12 mm.

Each tubular membrane duct 10 has an axial extension L of between 1000 mm and 5000 mm.

The tubular membrane ducts 10 of the said filtration device 2 all have substantially the same length L and substantially the same diameter D.

Each tubular membrane duct 10 is composed of at least one microporous inner layer, made for example with a microporous polymer having a porosity of between 0.015 micron and 0.05 micron, and a macroporous outer layer, made with a macroporous polymer having a porosity of between 0.5 and 5 micron.

The filtering function is performed mainly by the microporous inner layer which traps the sludge, allowing filtration of the liquid to the outermost layer and consequently to the sleeve 11 which collects the filtered liquid and via the lateral outlet 12 conveys it to a temporary storage tank S1.

The tubular membrane ducts 10 are bound together, in their end portions, by an epoxy resin 13 in the form of a support mesh which also acts as a sealant.

Owing to the high turbulence due to the ejector 4, micro-bubbles form and these remain in continuous movement inside the liquid; therefore, there is an effective transfer of oxygen from the gaseous phase to the liquid phase, even in the presence of a high sludge concentration, of more than 20 kg/m³.

The same turbulence facilitates the filtration process of the filtration device 2, preventing polarization of the concentration in the vicinity of the surface of the membrane itself, keeping it clean. The filtration performance therefore remains constant over time.

At least one main pumping device P1 operated by an electric motor (not shown in the figures) is provided directly upstream of the sedimentation tank 5.

Preferably, the system has a single main pumping device P1.

In an advantageous embodiment thereof, the pumping device P1 draws off a portion of the biological sludge and wastewater mixture 5′ from the oxidation tank 5 and sends it to the ejector 4 situated on top of the oxidation tank 5 where the biological sludge with wastewater 5′ is situated.

The main pumping device (P1) is a pump of the centrifugal type having dimensions so as to obtain a flow rate of the circulating liquid less than 3.5 m/s and preferably a flow rate of the circulating liquid less than 2 m/s.

The main pumping device (P1) has dimensions such as to produce, in terms of head, a head loss only of the ejector 4.

This is due to the fact that the pressure and therefore the speed necessary for correct operation of the filtration device 2 are obtained by means of the pressure recovered by the expanding portion of the ejector 4.

With such a dimensional design it is possible to use in an optimum manner the energy supplied to the system by the electric motor of the main pumping device P1.

The system may envisage a second secondary pumping device P2 for controlling with greater precision the flow rate of liquid filtered by the filtration device 2. Preferably the secondary pumping device P2 is a pump with an inverter.

After passing through the microfiltration membrane of the filtration device 2, the secondary pumping device P2 conveys the liquid fraction which filters through the filtration device 2 to a temporary storage tank S1.

The temporary storage tank S1 is arranged downstream of the filtration device 2 and collects the filtered liquid supplied from the filtration device 2 via the line 14.

According to an advantageous embodiment thereof, the pump P2 is reversible and may be used for mechanical flushing of the membrane. By reversing the flow, in fact, purified water is conveyed from outside to inside the ducts, thus removing any sludge deposits on the inner surface of the ducts.

The system envisages moreover at least one pressure meter for checking correct operation of the system itself.

Preferably the system has five pressure meters which are situated as follows: at the inlet of the ejector 4, at the outlet of the ejector 4, at the inlet of the filtration device 2, at the outlet of the filtration device 2 and one along the filtered-water line 14.

The system is particularly suitable for performing an aeration and filtration process for treating wastewater, comprising the following steps:

drawing off a quantity of wastewater and biological sludge mixture 5′ from the sedimentation tank 5;

adding oxygen to the aforementioned quantity of wastewater and biological sludge mixture 5′;

filtering the aforementioned quantity of the wastewater and biological sludge mixture 5′, now oxygenated, so as to obtain discharge liquid, namely water, and a remaining portion of oxygenated wastewater and biological sludge mixture 5′;

discharging from the filtration device 21 the aforementioned discharge liquid;

introducing the remaining portion of oxygenated wastewater and biological sludge mixture 5′ into the oxidation tank 5.

The oxygen addition step is performed by means of the ejector 4 which mixes a given flow of air and hence oxygen with the wastewater and biological sludge solution 5′ circulating inside the pipe 3.

After flowing out of the ejector 4, the wastewater and biological sludge mixture 5′ circulating inside the pipe 3 enters into the filtration device 2 which is installed in a vertical position alongside the sedimentation tank 5.

Preferably, the step of filtering the oxygenated flow of the wastewater and biological sludge mixture 5′ in order to obtain discharge liquid comprises a step of adding oxygen by means of the turbulence created by a tubular filtration membrane, such as the ducts 10.

The wastewater and biological sludge mixture 5′ to which oxygen has been added by means of the ejector 4 flows inside the tubular membrane ducts 10.

The air bubbles, which are formed by means of the pressure, create inside the small ducts 10 a high turbulence condition which, on the one hand, allows efficient transfer of the oxygen from the liquid phase and, on the other hand, keeps the surface of the microfiltration membrane clean.

As a result of the residual pressure, the water flow filters and passes through the microfiltration membrane and is collected inside the sleeve 11 and, via the outlet 12 and the line 14, is conveyed to a temporary storage tank S1.

The remaining portion of wastewater and biological sludge mixture 5′, to which oxygen has been added by the filtration device 2, is introduced again into the oxidation tank 5.

Preferably the step of introducing the remaining portion of wastewater and biological sludge mixture 5′ comprises a further step in which oxygen is added inside the sedimentation tank 5.

During this step, the oxygen is added inside the oxidation tank 5 by means of the movement induced by the mixer nozzles U.

In the process according to the present invention, as a result of the high turbulence due to the ejector 4, micro-bubbles are formed and these remain in continuous movement inside the liquid; therefore there is efficient transfer of oxygen from the gas phase to the liquid phase, even in the presence of a high sludge concentration, greater than 20 kg/m³. The same turbulence facilitates the filtration process on the membrane of the filtration device 2, preventing polarization of the concentration in the vicinity of the surface of the membrane itself, keeping it clean. The filtration performance therefore remains constant over time.

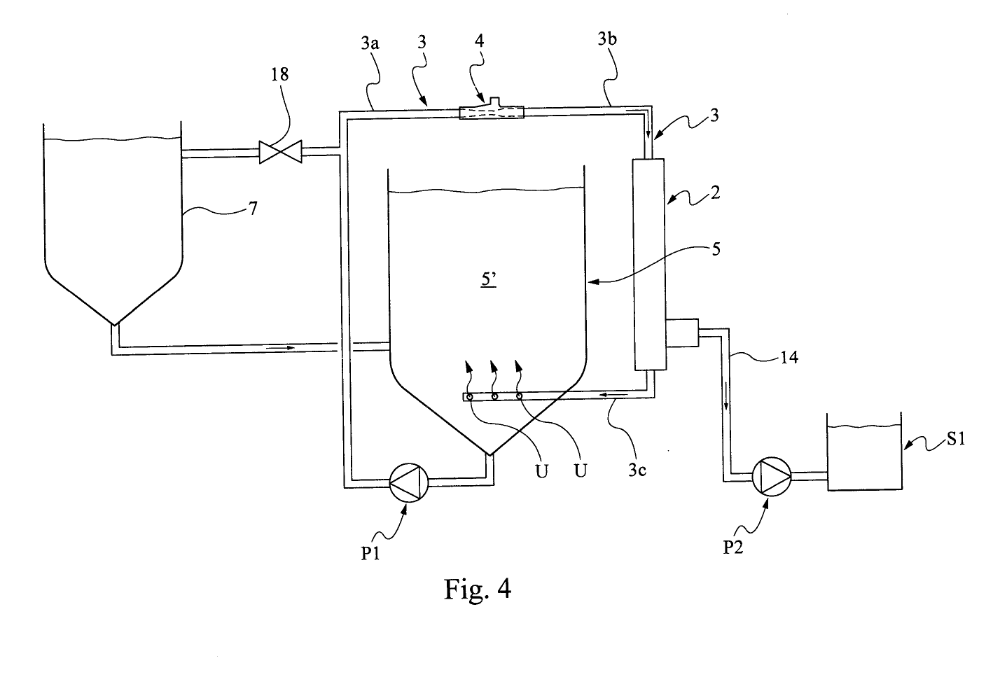

FIG. 4 shows an alternative embodiment of the system 1 according to the present invention in which the parts corresponding to those of the system shown in FIG. 1 have been shown with the same reference number.

The system 1 according to FIG. 4 is entirely similar to that shown in FIG. 1 except for the presence of a denitrification tank 7 and a valve 18, for example a gate valve 18.

The denitrification tank 7 is situated upstream of the main pumping device (P1).

Owing to the denitrification tank 7 the process is able to include a denitrification step for eliminating or in any case reducing the nitrogen in the form of elementary nitrogen.

1. An aeration and filtration system for treating wastewater, comprising:
at least one oxidation tank able to contain a mixture of wastewater and biological sludge;
at least one ejector able to mix gas, comprising oxygen, with at least one portion of said wastewater and biological sludge mixture;
at least one filtration device;
at least one pipe able to convey the wastewater and biological sludge mixture from the oxidation tank to the said at least one filtration device, wherein the said at least one ejector is arranged along said pipe and the said at least one filtration device is situated downstream of the said at least one ejector and comprises at least one filtration membrane comprising micropores.

2. The aeration and filtration system for treating wastewater according to claim 1, wherein the said at least one ejector comprises a Venturi ejector.

3. The aeration and filtration system for treating wastewater according to claim 1, wherein the ejector is positioned above the oxidation tank and is able to mix a predefined quantity of oxygen with a portion of wastewater and biological sludge mixture.

4. The aeration and filtration system for treating wastewater according to claim 1, wherein said ejector comprises a body with an inlet opening, an outlet opening and a passage which passes through the said body, said passage having an inlet section communicating with the said inlet opening, an outlet section communicating with said outlet opening, a constricting section, a substantially cylindrical throat section and an expanding section between said inlet section and said outlet section, an intake port formed in the said throat section; said constricting section and said throat section being suitably designed to form a reduced pressure region in the said throat section.

5. The aeration and filtration system for treating wastewater according to claim 1 in which the said filtration device comprises at least one duct and an outer containing sleeve functionally connected to the said ejector.

6. The aeration and filtration system for treating wastewater according to claim 5 in which the said duct comprises a filtration membrane.

7. The aeration and filtration system for treating wastewater according to claim 6 in which the membrane is a microfiltration member with pores having a size ranging from 0.01 a 0.2 micron.

8. The aeration and filtration system for treating wastewater according to claim 6 in which the membrane is a tubular microfiltration membrane with a diameter ranging between 3 mm and 15 mm.

9. The aeration and filtration system for treating wastewater according to claim 6 in which the membrane is a tubular microfiltration membrane with a length ranging between 1000 mm and 5000 mm.

10. The aration and filtration system for treating wastewater according to claim 1 wherein the system comprises at least one main pumping device for extracting a portion of wastewater and biological sludge mixture from the oxidation tank.

11. The aeration and filtration system for treating wastewater according to claim 10, wherein the said at least one main pumping device has dimensions such as to produce a flow rate of the circulating liquid equal to less than 3.5 m/s.

12. The aeration and filtration system for treating wastewater according to claim 1 further comprising at least one secondary pumping device for conveying a liquid fraction which filters through the filtration device to a storage tank.

13. The aeration and filtration system for treating wastewater according to claim 10 wherein the system comprises at least one denitrification tank situated upstream of the said main pumping device.

14. An Aeration and filtration process for treating wastewater with a system comprising:
at least one oxidation tank able to contain a wastewater and biological sludge mixture;
at least one ejector able to mix gas comprising oxygen with at least one portion of said wastewater and biological sludge mixture;
at least one filtration device;
at least one pipe able to convey the wastewater and biological sludge solution from the oxidation tank to the said at least one filtration device;
the process comprising the steps of:
drawing off a quantity of wastewater and biological sludge mixture from said sedimentation tank;
adding oxygen to the said quantity of wastewater and biological sludge mixture;
filtering the oxygenated flow of wastewater and biological sludge mixture so as to obtain discharge liquid;
discharging the said discharge liquid; and
introducing the remaining portion of oxygenated wastewater and biological sludge mixture into the said oxidation tank.

15. A process according to claim 14, wherein the step of introducing the remaining portion of wastewater and biological sludge mixture comprises a step involving addition of oxygen inside the said sedimentation tank.

16. A process according to claim 15, wherein the step of adding oxygen inside said oxidation tank is performed by means of the movement induced by at least one mixer nozzle.

17. A process according to claim 14, wherein the step of filtering the oxygenated flow of wastewater and biological sludge mixture so as to obtain discharge liquid comprises a step of adding oxygen by means of the turbulence created by a tubular filtration membrane.

18. A process according to claim 14, further comprising a denitrification step.
